(19) United States
(12) Patent Application Publication
(10) Pub. No.: US 2011/0100922 A1
(43) Pub. Date: May 5, 2011

(54) TREATMENT VESSEL FOR A WASTE WATER TREATMENT PROCESS SYSTEM

(75) Inventor: Phil Krasnostein, Silverwater (AU)

(73) Assignee: NUBIAN WATER SYSTEMS PTY LIMITED, Silverwater (AU)

(21) Appl. No.: 12/610,492

(22) Filed: Nov. 2, 2009

(51) Int. Cl. C02F 1/42

(52) U.S. Cl. 210/678; 210/284

(57) ABSTRACT

A treatment vessel (10) for a waste water treatment process system. The vessel (10) including a first section (12) and a second section (14). The first section (12) has a substantially constant first cross sectional area and is adapted for housing a granulated aerated charcoal biofilter material. The second section (14) has a substantially constant second cross sectional area, is below the first section (12) and is in fluid communication with the first section (12). The second section (14) is adapted for housing a sand filter material. The second cross sectional area is about 30 to 70% of the first cross sectional area.

### FIELD OF THE INVENTION

The present invention relates to a treatment vessel for a waste water process system.

The vessel has been primarily developed for use in treating grey water waste generated from office buildings, for example from laundry and bathroom (showers, baths and basins) water sources and will be described hereinafter with reference to this application. However, the invention is not limited to this application and is also suitable for use in residential (ie. domestic) and other applications requiring the removal of bio-degradable materials from low strength water streams, and the further treatment of partially treated sewage, car-wash waste water and commercial laundry waste water.

### BACKGROUND OF THE INVENTION

The Applicant's International PCT Patent Application No. PCT/AU2005/001774 (WO 2006/053402) discloses a waste water treatment process system utilising a treatment vessel using a circulating filter bed above a static filter bed. The disclosed circulating filter bed utilises a particulate material, in the form of a granulated activated carbon (“GAC”). The disclosed static filter bed utilises a denser particulate material, in the form of sand. The disclosed treatment vessel is an elongate cylindrical structure with a constant cross-sectional area over its length and is mounted with its longitudinal axis vertical.

In use, waste water to be treated is introduced into the top of the treatment vessel and treated water exits the bottom of the treatment vessel. Over time, the circulating filter bed and the static bed accumulate material filtered out of the waste water, particularly biomass material. The biomass material binds into the GAC and sand particles and eventually blocks the filter beds.

The treatment vessel is cleaned by a process known as backwashing which involves introducing water into the bottom of the treatment vessel and forcing it through the static filter bed and then through the circulating filter bed in order to remove the accumulated material. However, a blocked circulating filter bed can act as a plug during backwashing and in some circumstances can be forced upwardly towards and through the top of the treatment vessel. This results in both a physical and environmental safety hazard. To alleviate this problem, it is known to form the region of the treatment vessel that houses the circulating filter bed with a slight upward and outward taper. With this arrangement, the backwashing water lifts the plug of circulating filter bed material, allowing backwashing water to rush past the sides of the plug and eventually collapse the plug.

The overall aim of the backwashing process is to lift and separate (i.e. expand) the particles of the circulating filter bed, in order to release waste particles trapped therebetween. As previously mentioned, the sand utilised in the static filter bed is denser than the GAC utilised in the circulating filter bed. A disadvantage of the treatment vessels described above is that they make it extremely difficult to select a suitable backwashing velocity for the backwashing water. If the velocity is too low, then particle separation is not caused in the static filter bed and no backwashing occurs. If the velocity is too high, then the GAC and biomass particles in the circulating filter bed may be forced out of the top of the treatment vessel with the backwashing water.

### OBJECT OF THE INVENTION

It is the object of the present invention to substantially overcome or at least is ameliorate the above disadvantage.

### SUMMARY OF THE INVENTION

Accordingly, in a first aspect, the present invention provides a treatment vessel for a waste water treatment process system, the vessel including:

a first section, of a substantially constant first cross sectional area, adapted for housing a granulated aerated charcoal biofilter material; and

a second section, of a substantially constant second cross sectional area, below the first section and in fluid communication with the first section, the second section adapted for housing a sand filter material,

wherein the second cross sectional area is about 30 to 70% of the first cross sectional area.

The second cross sectional area is preferably about 50% of the first cross sectional area.

The vessel preferably includes an upwardly and outwardly tapered transition between the first section and the second section.

The vessel preferably also includes a third section, of a substantially constant third cross sectional area, above the first section and in fluid communication with the first section. In one form, the third section houses a media trap,

wherein the first cross sectional area that is about 30 to 70% of the third cross sectional area.

The first cross sectional area is preferably about 50% of the third cross sectional area.

The vessel preferably includes an upwardly and outwardly tapered transition between the first section and the third section.

The first section is preferably slightly upwardly and outwardly tapered.

The vessel is preferably a submerged, aerated, biofilter treatment vessel.

In a second aspect, the present invention provides a method for backwashing a treatment vessel for a waste water treatment process system, the vessel including: a first section, of a substantially constant first cross sectional area, adapted for housing a granulated aerated charcoal biofilter material; and a second section, of a substantially constant second cross sectional area, below the first section and in fluid communication with the first section, the second section adapted for housing a sand filter material,

the method including the step of forcing water upwardly through the first section at a velocity that is about 30% to 70% of the velocity of the water forced through the second section.

The method preferably includes the step of forcing water upwardly through the first section at a velocity that is about 50% of the velocity of the water forced through the second section.

The vessel preferably a third section, of a substantially constant third cross sectional area, above the first section and in fluid communication with the first section, the third section adapted for housing a media trap, and the method preferably includes the step of forcing water upwardly through the third section at a velocity that is about 30% to 70% of the velocity of the water forced through the first section.

The method preferably includes the step of forcing water upwardly through the third section at a velocity that is about 50% of the velocity of the water forced through the first section.

### BRIEF DESCRIPTION OF THE DRAWINGS

A preferred embodiment of the invention will now be described, by way of an example only, with reference to the accompanying drawings in which:

FIG. 1 is a front view of an embodiment of a treatment vessel for a waste water treatment process system;

FIG. 2 is a side view of the treatment vessel shown in FIG. 1; and

FIG. 3 is a perspective view of the treatment vessel shown in FIG. 1

### DETAILED DESCRIPTION OF THE PREFERRED EMBODIMENTS

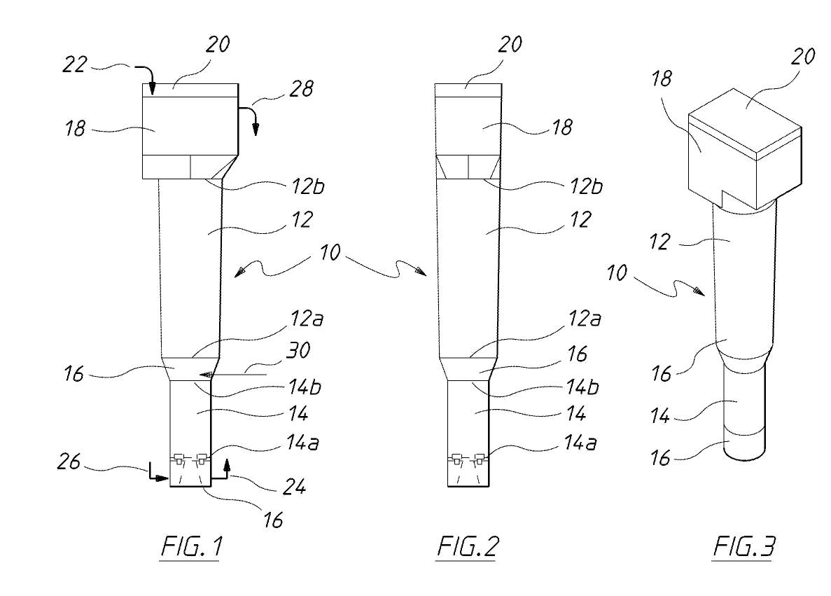

Referring to FIGS. 1 to 3, there is shown an embodiment of a treatment vessel 10 for a waste water process system, such as the system disclosed in the Applicant's previously mentioned PCT patent application (the relevant contents of which are incorporated herein by cross-reference).

The vessel 10 includes a first section 12 for housing a GAC biofilter material. The first section 12 is generally cylindrical in nature, having a substantially constant round cross-section of approximately 55,177 mm² surface area. However, whilst the cross-sectional area of the first section is described as substantially constant, it should be noted that the first section 12 does have a slight upward and outward taper from a diameter of 250 mm at its bottom end 12a to a diameter of 280 mm at its top end 12b.

The vessel 10 also includes a second section 14 for housing a sand filter material. The second section 14 is cylindrical with a diameter of 180 mm and a constant cross-sectional area of approximately 25,447 mm². The second section 14 has a bottom end 14a and a top end 14b. An upwardly and outwardly tapered transition 16 connects the top end 14b of the second section 14 to the bottom end 12a of the first section 12. The bottom end 14a of the second section 14 is connected to a plenum chamber 16. The top end 12b of the first section is connected to a head zone 18 which has a lid 20. The head zone 18 has a substantially constant rectangular cross-sectional area of 122,550 mm².

The treatment vessel is used with its longitudinal axis vertical and has a total height of approximately 1782 mm, comprising: 120 mm of plenum chamber 16; 350 mm of the second section 14; 100 mm of the transition 16; 800 mm of the first section 12, and 412 mm of the head zone 18.

The use of the vessel 10 shall now be described. As the vessel 10 is hollow, the head zone 18 is in fluid communication with the first section 12, the first section 12 is in fluid communication with the transition 16, the transition 16 is in fluid communication with the second section 14 and the second section 14 is in fluid communication with the plenum chamber 16.

To treat residential grey water domestic waste, a flow of influent grey water is introduced to the head zone 18, as indicated by arrow 22. The grey water flows downwardly through the head zone 18, through the first section 12, through the transition 16 and through the second section 14 and so to the plenum chamber 16, whereafter the treated grey water exits, as indicated by arrow 24, for collection and/or re-use. A detailed explanation of the treatment process is contained in the Applicant's previously mentioned PCT application. During this treatment process, air is injected into the vessel 10 adjacent the top end 14b of the second section, as indicated by arrow 30, and as described in the Applicant's previously mentioned PCT application.

During backwashing, backwashing water is introduced into the plenum chamber, as indicated by arrow 26, at a pressure sufficient to achieve the preferred backwash volumetric flowrate, for example about 40-50 psi in the vessel 10. The water is forced upwardly through the second section 14, then the transition 16, then the first section 12 and so to the head zone 18. The backwashing water and waste material then overflows to sewer, as indicated by arrow 28. A detailed description of the backwashing process is described in the Applicant's previously mentioned PCT application.

The backwashing water travels through the second section 14 at approximately 40 metres per hour, which is an optimum velocity for causing bed expansion in the sand filter material in order to effectively clean same. As the backwashing water enters the first section 12, the approximate doubling in cross-sectional area relative to the second section 14 causes a corresponding approximate halving of the backwashing water velocity to approximately 20 to 25 metres per hour. This speed is optimum for causing bed expansion in the GAC filter material for effective cleaning and biomass removal, and without entraining the GAC filter material and biomass into the water entering the head zone 18, where it would overflow to sewer, and necessitate expensive replacement. The difference in cross-sectional area between the second section 12 and the head zone 18 causes a further reduction in the velocity of the backwashing water to approximately 10-15 metres per hour. This velocity is optimum for allowing any entrained GAC filter particles to fall back into the first section 12, with only very fine particles being removed via the overflow indicated by arrow 28.

In summary, the advantage provided by the vessel 10 is that it optimises the velocity of the backwashing water flowing through the various sections of the vessel in order to optimise bed expansion and cleaning therein. This maximises the release of unwanted particulate material whilst minimising the loss of the filter materials themselves during the backwashing process.

Although the invention has been described with reference to a preferred embodiment, a person skilled in the art will appreciate that the invention may be embodied in many other forms. For example, the vessel can have varying cross sectional areas according to the required volumetric flows of the influent water, varying relative cross sectional areas according to various combinations of media used in the two filter beds and varying bed heights. It can also be operated with multiple air injection points, and can be operated with air assisted backwashing. It can also be separated into two vessels, one acting as an aerated biofilter followed by a vessel containing the static non-aerated bed.

1. A treatment vessel for a waste water treatment process system, the vessel including:
a first section, of a substantially constant first cross sectional area, adapted for housing a granulated aerated charcoal biofilter material; and
a second section, of a substantially constant second cross sectional area, below the first section and in fluid communication with the first section, the second section adapted for housing a sand filter material,
wherein the second cross sectional area is about 30 to 70% of the first cross sectional area.

2. The treatment vessel as claimed in claim 1, wherein the second cross sectional area is about 50% of the first cross sectional area.

3. The treatment vessel as claimed in claim 1, wherein the vessel includes an upwardly and outwardly tapered transition between the first section and the second section.

4. The treatment vessel as claimed in claim 1, wherein the vessel also includes a third section, of a substantially constant third cross sectional area, above the first section and in fluid communication with the first section, wherein the first cross sectional area that is about 30 to 70% of the third cross sectional area.

5. The treatment vessel as claimed in claim 4, wherein the third section houses a media trap.

6. The treatment vessel as claimed in claim 4, wherein the first cross sectional area is about 50% of the third cross sectional area.

7. The treatment vessel as claimed in claim 4, wherein the vessel includes an upwardly and outwardly tapered transition between the first section and the third section.

8. The treatment vessel as claimed in claim 1, wherein the first section is slightly upwardly and outwardly tapered.

9. The treatment vessel as claimed in claim 1, wherein the vessel is a submerged, aerated, biofilter treatment vessel.

10. A method for backwashing a treatment vessel for a waste water treatment process system, the vessel including: a first section, of a substantially constant first cross sectional area, adapted for housing a granulated aerated charcoal biofilter material; and a second section, of a substantially constant second cross sectional area, below the first section and in fluid communication with the first section, the second section adapted for housing a sand filter material,
the method including the step of forcing water upwardly through the first section at a velocity that is about 30% to 70% of the velocity of the water forced through the second section.

11. The method as claimed in claim 10, wherein the method includes the step of forcing water upwardly through the first section at a velocity that is about 50% of the velocity of the water forced through the second section.

12. The method as claimed in claim 10, wherein the vessel includes a third section, of a substantially constant third cross sectional area, above the first section and in fluid communication with the first section, the third section adapted for housing a media trap, and the method includes the step of forcing water upwardly through the third section at a velocity that is about 30% to 70% of the velocity of the water forced through the first section.

13. The method as claimed in claim 12, wherein the method includes the step of forcing water upwardly through the third section at a velocity that is about 50% of the velocity of the water forced through the first section.
